(19) United States
(12) Patent Application Publication
(10) Pub. No.: US 2020/0149515 A1
(43) Pub. Date: May 14, 2020

(54) PITCH BEARING ARRANGEMENT

(71) Applicant: Siemens Gamesa Renewable Energy A/S, Brande (DK)

(72) Inventors: Karsten Buch-Lorentsen, Ry (DK); Klaus Hjorth Hansen, Jelling (DK)

(21) Appl. No.: 16/666,533

(22) Filed: Oct. 29, 2019

(30) Foreign Application Priority Data
Nov. 13, 2018 (EP) 18205946.9

(51) Int. Cl. F03D 80/70; F16C 33/58

(52) U.S. Cl. CPC F03D 80/70; F16C 2360/31; F16C 33/58

(57) ABSTRACT

Provided is a pitch bearing arrangement of a wind turbine, including an outer bearing ring and an inner bearing ring arranged coaxially to each other and including a common symmetry axis, and at least one reinforcement plate arranged at the inner ring and at least one plate-like or beam-like stiffening means coupled to the outer ring axially adjacent to the at least one reinforcement plates and adapted to be coupled to a positioning means to be arranged at the other side of the at least one reinforcement plate used for pivoting the outer ring relative to the inner ring, with the at least one reinforcement plate including at least one hole through which the stiffening means is mechanically connectable or connected to the positioning means.

### CROSS-REFERENCE TO RELATED APPLICATIONS

This application claims priority to European Application No. 18205946.9, having a filing date of Nov. 13, 2018, the entire contents of which are hereby incorporated by reference.

### FIELD OF TECHNOLOGY

The following relates to a pitch bearing arrangement of a wind turbine, comprising an outer bearing ring and an inner bearing ring arranged coaxially to each other and comprising a common symmetry axis, and at least one reinforcement plate arranged at the inner ring.

### BACKGROUND

Large industrial type horizontal axis wind turbines typically comprise a pitch regulation for controlling the orientation of the respective rotor blades with regard to the incoming air flow of the wind. In comparison to a stall regulated wind turbine, where the rotor blades a rigidly fixed to the hub of the wind turbine, the pitch regulated rotor blades are pivotable mounted to the hub. This allows to choose the orientation of the rotor blades with regard to the incoming air flow such that the amount of generated electricity by the wind turbine is optimized. Typically, the rotor blades are mounted to the hub by means of a bearing comprising an inner bearing ring and an outer bearing ring coaxially arranged to each other with rolling elements sandwiched between the two rings, for example tapered rollers or ball bearing arrangements. As wind turbines become larger and larger and consequently the rotor blades size increases, the forces which are transferred from the respective rotor blade to the hub via the pitch bearing increase as well. In order to reinforce the pitch bearing a reinforcement plate is arranged at the inner bearing, or in an alternative a pair of reinforcement plates is arranged at the inner bearing ring as disclosed in EP 2 045 464 A2 or EP 2 933 476 A1. Such reinforcement plate(s) improve the stiffness of the bearing.

Usually the rotor blade is connected to the inner ring of the bearing, while the hub is connected to the outer bearing ring. For pitching the rotor blade the pitch drive and the respective mechanic components like pitch cylinders, pitch gear etc. are arranged in the hub. For allowing the maintenance personal to access the hub for maintenance purpose the reinforcement plate comprises a manhole, whereas if two reinforcement plates are present, as disclosed in EP 2 933 476 A1, such an arrangement comprises two manholes, through which the maintenance personal can access the blade via the hub. Maintenance of the major component is therefore possible directly in the hub and manholes in the reinforcement plates do not need to be bigger due to pitch component exchange. In an arrangement where the blade is connected to the outer ring and the hub is connected to the inner ring the pitch components are either placed inside the blade or on the outside of the hub. In both places the service and exchange of components is difficult as there is no easy access through a manhole from the hub.

### SUMMARY

An aspect relates to an improved pitch bearing arrangement.

To achieve this aspect a pitch bearing arrangement is provided, characterized by at least one plate-like or beam-like stiffening means coupled to the outer ring axially adjacent to the at least one reinforcement plate and adapted to be coupled to a positioning means to be arranged at the other side of the at least one reinforcement plate used for pivoting the outer ring relative to the inner ring, with the at least one reinforcement plate comprising at least one hole through which the stiffening means is mechanically connectable or connected to the positioning means. In this embodiment only one reinforcement plate with at least one hole is provided.

In a similar approach to the embodiment with only one reinforcement plate two or more reinforcement plates are provided, with the at least one stiffening means being provided adjacent to one of the reinforcement plates and the positioning means being provided adjacent to another of the reinforcement plates, with the two or more reinforcement plates comprising axially corresponding holes through which the stiffening means is mechanically connectable or connected to the positioning means. In this embodiment the at least one plate-like or beam-like stiffening member therefore is coupled to the outer ring axially adjacent to one of the reinforcement plates and adapted to be coupled to a positioning means to be arranged adjacent to the other or, in case of e.g. three or more reinforcement plates, the outermost reinforcement plate, with the reinforcement plates comprising at least two axially corresponding holes through which the stiffening means is mechanically connectable or connected to the positioning means.

The inventive pitch bearing arrangement allows the installation of the central mechanical drive components for pitching the rotor blade in the hub, although the blade may be connected to the outer ring and the hub to the inner ring. This is possible, as the inventive pitch bearing arrangement is designed to have a mechanical connection from the inner of the hub to the inner of the blade through one or more respective connection holes provided in the one or the more reinforcement plates. The pitch bearing arrangement comprises at least one plate- or beam-like stiffening member, which is arranged at or at least mechanically coupled to the outer ring. This stiffening mean is the mechanical connection basis for coupling the outer ring to the pitch drive arranged on the other side of the reinforcement plate arrangement in the hub. In the hub the respective drive components like pitch cylinder, pitch gear etc. are arranged. This drive components are mechanically connected to the stiffening means and thus to the outer ring through a respective connection arrangement extending through the corresponding hole(s) in the reinforcement plate(s).

As the relevant drive components in the inventive pitch bearing arrangement may now be arranged in the hub, maintenance is eased, as the maintenance personal can access these components directly in the hub, there is no need to access the blade. No large manhole(s) need(s) to be provided in the reinforcement plate(s), but only small, adapted holes for allowing the mechanical connection to the drive components in the hub. However, access ways to the blade may nevertheless also be provided in case maintenance is required in the interior of the blades.

For connecting the stiffening means to the positioning means, a mechanical connection means is provided. This mechanical connection means couples the stiffening means to the positioning means, for example the pitch cylinder or the like. Regarding the mechanical connection means several various embodiments are possible.

According to a first embodiment, the mechanical connection means is accommodated in the one or the more holes. In this embodiment the stiffening means is flat, like a flat plate, a flat ring plate or one or more flat beams. They extend parallel to the adjacent reinforcement plate. For connecting the drive means arranged in the hub to this flat stiffening means an elongated mechanical connection means like a respective rod or the like is with one end connected to the stiffening means and with the other end to the drive means and extends through the one or the more holes of the reinforcement plate(s). The mechanical connection means is for example firmly attached to the stiffening means but pivotably attached to the drive means, for example the pitch cylinder, which pitch cylinder is attached with the other end to a respective holding means arranged at the hub.

The one or the two or more axially corresponding holes are arranged eccentrical to the common axis, so that, when the pitch cylinder is activated and the plunger for example is pushed out of the cylinder, the respective longitudinal movement is transferred to the stiffening means resulting in a rotational movement of the outer ring and thus the blade.

In one embodiment the one or each of the reinforcement plates comprise two single holes (in case one reinforcement plate is provided) or two pairs of holes (in case two reinforcement plates are provided) arranged equally or unequally distributed around the common axis for accommodating two connection means. In this embodiment two separate drive means are arranged in the hub, which are separately connected by separate mechanical connection means to for example a common stiffening means. For this mechanical connection two pairs of respective axially corresponding holes, through which the mechanical connection means extend, are provided in the reinforcement plates. Thus a 180° arrangement is realized. Usually both drive means are activated synchronously, so that the rotational force is transferred to the stiffening means and thus the outer ring in a symmetrical way.

Each single hole or each hole of the one or the two pairs is in one embodiment kidney-shaped and should be as small as possible, as it is only used as a through hole for accommodating the mechanical connection means. Due to the kidney-form it follows the rotational movement performed by the mechanical connection mean due to the rotation of the stiffening member. The hole may however also resemble other shapes, e.g. circular, oval, triangular, rectangular or any other multisided shape, as long as the connection members can move freely.

In an alternative embodiment comprising two reinforcement plates both reinforcement plates are ring-shaped and comprise axially corresponding center holes for accommodating the connection means. In this embodiment the corresponding holes are not eccentric but are center holes right in the middle of the respective plates. Nevertheless, also in this embodiment the connection means is arranged eccentrical to the common axis, as the longitudinal movement of the drive means, i.e. a pitch cylinder needs to be transferred into a rotational movement.

Also, in this embodiment two separate connection means are arranged eccentrical and equally or unequally distributed around the common axis, with each connection means being connected to a separate drive means for allowing also in this embodiment to symmetrically drive the outer ring respectively the hub. In an alternative to the eccentric arrangement a centric carrier, like a tube or a rod or a block, with a gear ring connected or connectable to the positioning means may be provided.

As already explained, in the above-mentioned embodiments the reinforcement plates are parallel to each other, with the stiffening means being parallel to the adjacent reinforcement plate. In an alternative the reinforcement plates may also be angled to each other.

The previously disclosed embodiment comprises separate mechanical connection means extending through the hole or the holes provided in the reinforcement plate(s). In another embodiment of the invention comprising two or more reinforcement plates the reinforcement plates are ring-shaped and comprise axially corresponding center holes for accommodating a section of the stiffening means extending into or through the holes. In this embodiment the stiffening means is not flat but has a specific geometry providing a section which runs into or through the respective holes of the reinforcement plates. Thus, the attachment plane for attaching a connection means for connecting the stiffening means, which connection means are attached to the section bottom arranged in or below the holes, is moved to the side of the hub, where the drive components are arranged. Therefore, no elongated connection means are necessary, but only small, short connection means allowing to mechanically connect the drive means, for example the pitch cylinder, to the stiffening means section.

The section itself is, at least in part, provided with a single wall structure, alternatively also a double wall structure may be provided.

In this embodiment the reinforcement plate adjacent to the stiffening mean may either have a cone form, while also the stiffening mean has a corresponding cone form. The two reinforcement plates are therefore not parallel to each other. The one reinforcement plate close to the hub is flat, while the second reinforcement plate close to the blade has the cone form. The stiffening means, either in form of a cone plate or a respectively bent beam or the like, has a corresponding form, so that it is nearly parallel to the cone reinforcement plate, so that the respective section extends into or through the center holes of the reinforcement plates.

In an alternative embodiment the reinforcement plate adjacent to the stiffening means has a flat form and the stiffening means has a trough-like form. In this embodiment, both reinforcement plates are parallel, also the stiffening means for example realized as a trough- or pot-like plate has a ring-shaped outer contour, which is parallel to the adjacent reinforcement plate, while the trough- or pot-like center extends or slightly through both reinforcement plate holes.

In any way the respective attachment plane of the section is arranged in the hole arrangement of the reinforcement plates or extends through the holes and thus lies completely below the lower reinforcement plate in the hub section.

In any case, the respective forms of the reinforcement plates and the stiffening means are not restricted to the above-mentioned geometric forms of the various embodiments. Also, other forms or arrangements of the plate(s) and the one or more stiffening means are possible, as long as they fulfil the respective purpose.

Aside the pitch bearing arrangement embodiments of the invention relates to a wind turbine, comprising a hub, at least one rotor blade and at least one pitch bearing arrangement as disclosed above, wherein the pitch bearing arrangement pivotably connects the rotor blade to the hub.

In a further embodiment the inventive wind turbine is characterized in that the rotor blade is attached to the outer ring and the hub to the inner ring, while that the positioning means is or are arranged inside the hub.

The hub as referred to herein can be a segmented hub comprised of two or more separate parts e.g. for ease of casting and transportation, which are assembled to make up a full hub. Likewise, the hub as referred to herein may comprise so called hub extenders already known in the art, which are essentially cylindrical hollow bodies extending from and attached to the hub and in turn the rotor blade root attached to the extender as with regular hubs. The extender may also be referred to as a root extender. The rotor blade bearing may be attached in-between the hub and an extender but placed in-between the extender and the rotor blade. In any case the pitch system as herein described is applicable to any given hub configuration i.e. a standard hub or a hub being segmented and/or comprising extenders.

### BRIEF DESCRIPTION

Some of the embodiments will be described in detail, with reference to the following figures, wherein like designations denote like members, wherein:

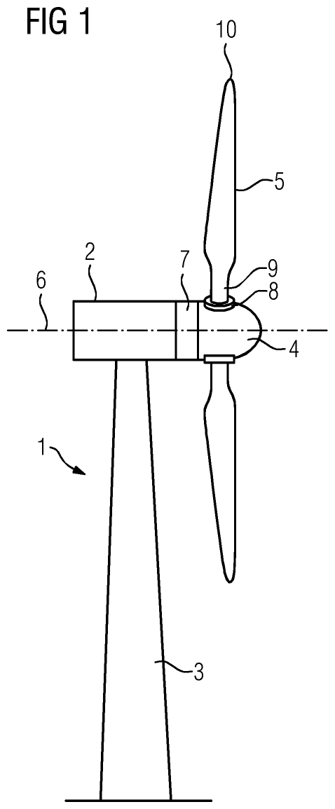

FIG. 1 shows a wind turbine with pitch regulated wind turbine rotor blades;

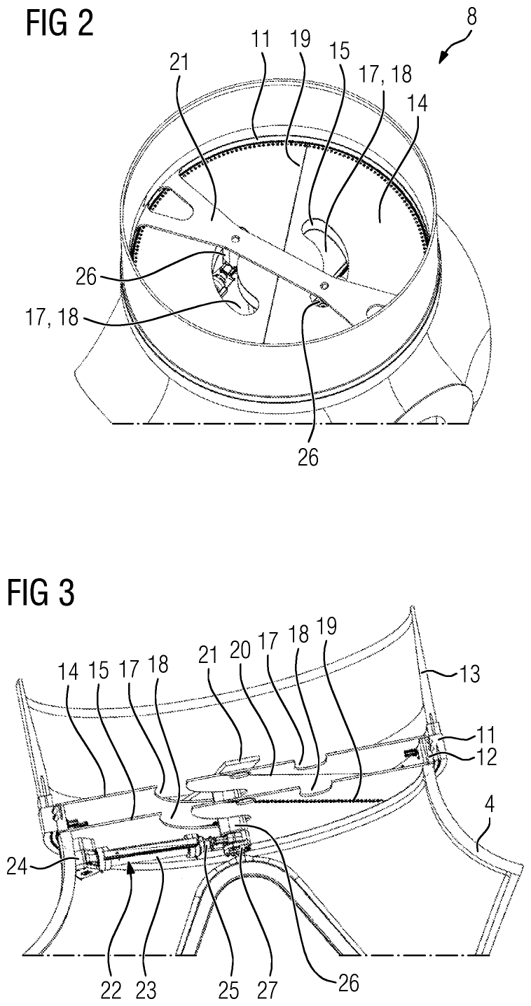

FIG. 2 show a perspective view of a pitch bearing arrangement according to a first embodiment;

FIG. 3 shows a perspective cut view of the arrangement of FIG. 2;

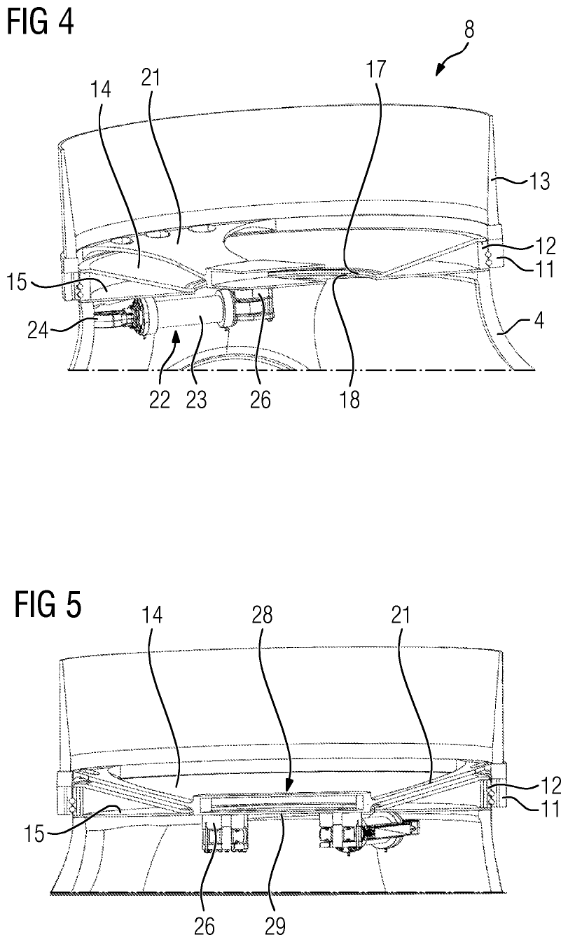

FIG. 4 shows a cut view of a pitch bearing arrangement of a second embodiment;

FIG. 5 shows a perspective cut view of the second embodiment; and

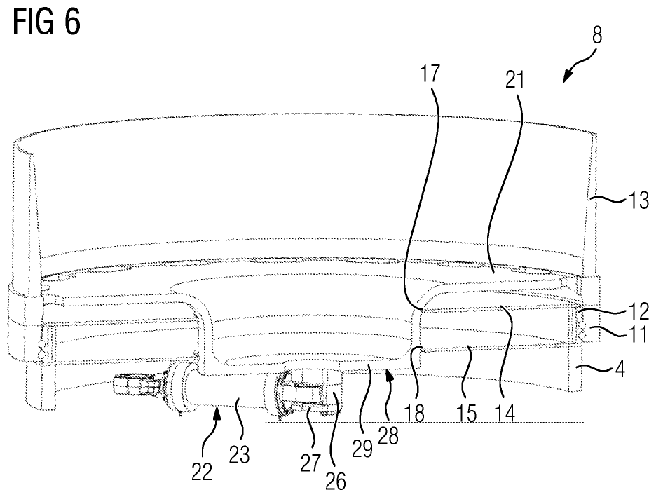

FIG. 6 shows a cut view of a third embodiment of an inventive pitch bearing arrangement.

### DETAILED DESCRIPTION

In FIG. 1 a wind turbine 1 is shown. The wind turbine 1 comprises a nacelle 2 and a tower 3. The nacelle 2 is mounted at the top of the tower 3. The nacelle 2 is mounted rotatable with regard to the tower 3 by means of a jaw bearing. The axis of rotation of a nacelle 2 with regard to the tower 3 is referred to as the jaw axis.

The wind turbine 1 furthermore comprises a hub 4 with one or more rotor blades 5, three rotor blades 5. The hub 4 is mounted rotatable relative to the nacelle 2 by means of a main bearing. The hub 4 is mounted rotatable about a rotor axis of rotation 6.

The wind turbine 1 furthermore comprises a main shaft connecting the hub 4 with a rotor of a generator 7. If the hub 4 is connected directly to the rotor, the wind turbine is referred to as a gearless, direct drive wind turbine. Alternatively, the hub 4 may also be connected to the rotor via a gear box. This type of wind turbine is commonly referred to as a geared wind turbine.

The generator 7 is accommodated within the nacelle 2. It comprises a rotor and a stator and, as known, converts the rotational energy from the rotor into electrical energy.

In the example shown in FIG. 1 the wind turbine 1 comprisesthree rotor blades 5, two of which are shown in FIG. 1. The rotor blades 5 are mounted rotatable with regard to the hub 4 by means of respective pitch bearing arrangements 8. The rotor blades 5 may thus be pitched in order to optimize their orientation with regard to the wind flow impinging on the wind turbine 1.

Each rotor blade 5 comprises a root section 9 and a tip section 10. The root section refers to the part of the rotor blade 5 which is closest to the hub 4 and pitch bearing arrangement 8. The common set up of such a wind turbine with pitchable blades is known.

FIG. 2 shows a first embodiment of an inventive pitch bearing arrangement 8. It comprises, see also FIG. 3, an outer bearing ring 11 and an inner bearing ring 12 with bearing elements, for example tapered rollers or balls, being arranged between the rings 11, 12. The inner ring 12 is connected to the hub 4, while the outer ring 11 is connected to a root element 13 which is part of the blade 5.

The pitch bearing arrangement 8 further comprises two reinforcement plates 14, 15 which are attached to the upper and lower end of the inner ring 11. The reinforcement plates 14, 15 are flat plates closing the inner of the inner bearing ring 12, see FIG. 2. Each reinforcement plate 14, 15 comprises two eccentrical arranged kidney-shaped holes 17, 18, which are axially aligned with each other forming two axially corresponding hole pairs as clearly shown in FIGS. 2, 3. As shown in the figures, the reinforcement plates 14, 15 may be realized by two plate halves, which are connected to each other in the middle, see the respective seams 19, 20. Each plate half comprises a respective hole 17, 18.

The inventive pitch bearing arrangement 8 further comprises a stiffening element 21 here in form of a flat beam, which is adjacent and parallel to the outer reinforcement plate 14 and in relative close distance to the plate 14. This stiffening means 21 is attached to the outer ring 11.

As FIG. 3 shows a positioning means 22 here comprising a pitch cylinder 23 is arranged within the hub 4. By means of a fixation element 24 it is attached to inner circumference of the hub 4 close to the lower reinforcement plate 15. The piston 25 which can be pushed out of the pitch cylinder 23 is connected to a mechanical connection means 26 via a pivot connection 27. The other end of this mechanical connection means 26 is firmly attached to the bottom side of the stiffening means 21, i.e. the flat elongated beam and extends through the corresponding holes 17, 18. In FIG. 3 only one positioning means 22 and one mechanical connection means 26 are shown. It is to be noted, that there is certainly a second positioning means 22 and a second mechanical connection means 26 arranged at the opposite side of the hub respectively in the other pair of eccentric holes 17, 18. Both mechanical connection means 26 are shown in FIG. 2.

The positioning means 22 are adapted to pivot the outer ring 11 relative to the inner ring 12 and thus to pitch the blade 5 relative to the hub. When the pistons 25 of both positioning means 22 are pushed out of the cylinder housing this linear movement is transferred to the connection means 26. Due to the pivot connection 27 the connection means 26 rotates relative to the positioning means and moves in the holes 17, 18 allowing the outer ring 11 to be rotated. Thus, simply by pushing the pistons 25 out or retracting them in the cylinder housing the outer ring 11 and thus the blade 5 can be pitched relative to the hub 4.

As it is obvious from FIG. 3 the positioning means and the connection means 26 are arranged in the hub and thus are accessible through the hub for maintenance purpose. There is in principle no need for the maintenance personal to enter the blade, as no relevant mechanical component is arranged in the blade but only in the hub.

FIGS. 4 and 5 show a second embodiment of an inventive pitch bearing arrangement 8. Again, the hub 4 and a root element 13 are shown which are connected to each other via the pitch bearing arrangement 8 comprising the outer ring 11 attached to the root element 13 and the inner ring 12 attached to the hub 4. The inner ring 12 again is reinforced by two reinforcement plates 14, 15. Both reinforcement plates 14, 15 are designed as ring plates comprising two center holes 17, 18. While the lower reinforcement plate 15 is a flat ring plate, the upper reinforcement plate 14 is a cone-shaped ring plate which is connected with its inner circumference to the inner circumference of the lower reinforcement plate 15 as shown in FIGS. 4 and 5.

Also, in this embodiment a stiffening means 21 is coupled to the outer ring 11. The stiffening means 21 has a bent form corresponding to the form of the cone-shaped upper reinforcement plate 14, see especially FIG. 5. Its center section 28 is in this embodiment double-layered and extends into the two plate holes 17, 18, so that the bottom 29 of this center section 28 corresponds to the plane in which the lower hole 18 is situated or extends even below this plane.

A mechanical connection means 26 is eccentrically attached to the bottom side 29 of the center section 28, to which connection means 26 the positioning means 22 respectively the pitch cylinder 23 is attached with its piston 25, while the cylinder housing is attached to the hub 4 by means of a fixation element 24. As the cut view of FIG. 5 shows, also in this embodiment two positioning means 22 and two respective eccentrical connection means 26 are provided, so that also in this embodiment the rotation of the outer ring 11 relative to the non-rotating inner ring 12 and thus the pitch of the blade 5 relative to the hub 4 can be realized by symmetrical rotation force.

Finally, FIG. 6 shows a third embodiment of an inventive pitch bearing arrangement 8 comprising an outer ring 11, an inner ring 12 attached to the blade route element 13 respectively the hub 4. The inner ring 11 is reinforced by means of reinforcement plates 14, 15, which are parallel to each other and comprise two respective center holes 17, 18 which are axially aligned.

The pitch bearing arrangement 8 further comprises a stiffening means 21 here in form of a trough-like or pot-like shaped plate which is attached to or coupled to the outer ring 11. The stiffening means 21 comprises a trough-like or pot-like center section 28 extending through both holes 17, 18. To the bottom side 29 of this trough-like or pot-like center section 28 the mechanical connection means 26 is attached, to which via a pivot connection 27 the piston of the positioning means 22, also here in form of a pitch cylinder 23 is attached. The other end of the positioning means 22 is again attached to the hub 4 via a not shown fixation element 24.

The position at the bottom side 29, to which the mechanical connection means 26 is attached, is eccentrical to the center axis to assure that the longitudinal movement of the piston is transferred to a rotational movement of the stiffening means 21 and thus the outer ring 11.

It is to be noted, that also in this embodiment a second positioning means 22 and a second mechanical connection means 26 is provided, which are arranged at a 180° position, thus also being attached eccentrical to the bottom side 29 for having a symmetrical force transfer on the stiffening means 21.

While the embodiments show two reinforcement plates, it is also possible to provide only one reinforcement plate and to connect the stiffening means through this one plate via a hole to the positioning means provided at the other plate side, with any of the connections being usable as shown in the pictures.

Although the present invention has been disclosed in the form of preferred embodiments and variations thereon, it will be understood that numerous additional modifications and variations could be made thereto without departing from the scope of the intention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A pitch bearing arrangement of a wind turbine, comprising:
an outer bearing ring and an inner bearing ring arranged coaxially to each other and comprising a common symmetry axis;
at least one reinforcement plate arranged at the inner ring; and
at least one plate-like or beam-like stiffening means coupled to the outer ring axially adjacent to the at least one reinforcement plate and adapted to be coupled to a positioning means to be arranged at an other side of the at least one reinforcement plate used for pivoting the outer ring relative to the inner ring, with the at least one reinforcement plate comprising at least one hole through which the stiffening means is mechanically connectable or connected to the positioning means.

2. The pitch bearing arrangement according to claim 1, wherein two or more reinforcement plates are provided, with the stiffening means being provided adjacent to one of the reinforcement plates and the positioning means being provided adjacent to another of the reinforcement plates, with the reinforcement plates comprising axially corresponding holes through which the stiffening means is mechanically connectable or connected to the positioning means.

3. The pitch bearing arrangement according to claim 1, wherein a mechanic connection means for connecting the stiffening means to the positioning means is provided.

4. The pitch bearing arrangement according to claim 3, wherein the mechanic connection means is accommodated in the hole or the holes.

5. The pitch bearing arrangement according to claim 4, wherein the hole or the corresponding holes are arranged eccentrical to the common axis.

6. The pitch bearing arrangement according to claim 5, wherein the one or the more reinforcement plates comprise two or more pairs of holes arranged equally or unequally distributed around the common axis for accommodating two connection means.

7. The pitch bearing arrangement according to claim 5, wherein the or each hole is kidney-shaped, circular, oval, triangular, rectangular or of any other multisided shape.

8. The pitch bearing arrangement according claim 4, wherein both reinforcement plates are ring-shaped and comprise axially corresponding center holes for accommodating the connection means.

9. The pitch bearing arrangement according to claim 8, wherein the connection means is arranged eccentrical to the common axis, or that a centric carrier with a gear ring connected or connectable to the positioning means is provided.

10. The pitch bearing according to claim 9, wherein two connection means are arranged eccentrical and equally or unequally distributed around the common axis.

11. The pitch bearing arrangement according to claim 2, wherein the reinforcement plates are parallel or angled to each other, with the stiffening means being parallel to the adjacent reinforcement plate.

12. The pitch bearing arrangement according to claim 1, wherein the one or the more reinforcement plates are ring-shaped and that the or each reinforcement plate comprises at least one center hole for accommodating a section of the stiffening means extending into or through the hole or the holes.

13. The pitch bearing arrangement according to claim 12, wherein the section at least in part has a single or a double wall structure.

14. The pitch bearing arrangement according to claim 12, wherein the reinforcement plate adjacent to the stiffening means has a cone form and that the stiffening means has a corresponding form, or that the reinforcement plate adjacent to the stiffening means has a flat form and the stiffening means has a trough-like form.

15. A wind turbine, comprising a hub, at least one rotor blade and at least on pitch bearing arrangement according to claim 1, wherein the pitch bearing arrangement pivotably connects the rotor blade to the hub.

16. The wind turbine according to claim 14, wherein the rotor blade is attached to the outer ring and the hub to the inner ring, and that the positioning means is or are arranged inside the hub.
